(19) United States
(12) Patent Application Publication
(10) Pub. No.: US 2006/0197703 A1
(43) Pub. Date: Sep. 7, 2006

(54) Hybrid-phased communication array

(76) Inventor: Janice C. Rock, Lacey's Spring, AL (US)

Correspondence Address: AMSAM-L-G-I (Michael K. Gray);US Army Aviation and Missile Command, Legal Office, 4th Floor, Building 5300, Redstone Arsenal, AL, 35898-5000, US

(21) Appl. No.: 11/071,428

(22) Filed: Mar. 3, 2005

(51) Int. Cl. H01Q 3/26

(52) U.S. Cl. 342/372

(57) ABSTRACT

A communication module is provided with a Transmit/Receive (T/R) element fabricated from psuedomorphic HEMT, High Electron Mobility Transistor technology (PHEMT). The T/R element drives multiple Radio Frequency MEMS switch-based phasing elements. Each of the phasing elements connects to a corresponding radiation element. A large quantity of the communication elements can be placed on a single substrate chip so as to provide for a reliable and cost effective device.

### DEDICATORY CLAUSE

The invention described herein may be manufactured, used and licensed by or for the U.S. Government for governmental purposes without payment of any royalties thereon.

### BACKGROUND OF THE INVENTION

I. Field of the Invention

The present invention pertains to drivers for radiating elements and electronically steerable arrays.

More particularly the present invention pertains to a communication device having a Transmit/Receive (T/R) element fabricated from HEMT (High Electron Mobility Transistor) technology, that advantageously drives multiple radiating elements.

II. Discussion of the Background

Historically, electronically steerable phased arrays have utilized two types of designs.

With reference to FIG. 1, the passive Electronically Steerable Array (ESA) 14 has a transmitter/receiver 18 for driving a plurality of arrayed phase shifters 16 that are connected to a radiating element or elements 10. The array 14 is passive in that it is dependent upon a single high-peak-power tube transmitter/receiver 18. Should the transmitter receiver 18 fail, the entire array 14 becomes inoperational.

In FIG. 2, an active Electronically Streerable Array 20 has many transmit receive elements as demonstrated in a row 22 of transmit/receive elements. Each of the transmit/receive elements of row or network 22 is directly connected to a corresponding phase element in row or network 24 of phase elements. In the active ESA of FIG. 2, the row 22 of T/R elements is positioned between the radiating element or elements 26 and the row of phase elements 24. In FIG. 4, the schematic diagram of an array column 25 demonstrates the element geometry of an active ESA in that the transmit/receive element 22₁ is positioned between the phase element 24₁ and the radiating element 26₁.

The schematic diagram of FIG. 3 will provide explanation for the reason transmit/receive element 22₁ of the active ESA is positioned between the phase element 24₁ and the radiating element 26₁.

With reference to FIG. 3, transmit/receive element 22₁ is comprised of a number of electrical components. A switch 48 alternatively connects radiating element 26₁ to low noise amplifier 28 during receive mode or to power amplifier 46 during transmit mode. Low-noise amplifier 28 connects to band-pass filter 30 that connects to a mixer 32. Mixer 32 mixes the received signal with a current received from an oscillator with the mixed signal proceeding to amplifier 34. Amplifier 34 connects to a switch 36 which opens and closes depending upon the mode of operation. Amplifier 38 is located between and connects to phase shifter 24₁ and to multiplier or mixer 42. A mixed signal proceeds from mixer 42 to band-pass filter 44 to power amplifier 46. When switch 48 connects to powr amplifier 48, a signal can be transmitted through radiating element 26₁.

To achieve the best performance for active ESA array elements such as those depicted in FIGS. 2-4, the low noise amplifier 28 needs to be positioned as close as possible to the radiating element 26₁ due to the relatively low peak power of the transmitter/receiver 22₁. As the distance of the low noise amplifier 28 from the radiating element increases, signal loss increases and performance decreases.

The transmitter/receiver 18 of the passive ESA of FIG. 1 has sufficient power to drive the radiating elements 10, but since the large drive signal has to travel through the phase shifters 16, unwanted noise is created. Further, as has been pointed out, should the transmitter/receiver 18 fail, the entire device will fail.

### SUMMARY OF THE INVENTION

Accordingly, one object of the present invention is to provide a communication module having a relatively low power T/R element which can drive a plurality of radiating elements.

Yet another object of the present invention is provide an array of communication modules with each module of the array having a respective low powered T/R element which effectively drives a corresponding respective plurality of radiating elements.

Still another object of the present invention an array of communication modules that are economical to manufacture.

These and other valuable objects are realized by a communication module that includes a PHEMT-T/R module; a plurality of phase elements; a switching means connecting the PHEMT-T/R module to the plurality of phase elements; and a plurality of radiating elements. Each phase element of the plurality of phase elements is directly connected to a corresponding radiating element of the plurality of radiating elements. The plurality of phase elements comprise RF MEMS switch-based phasing elements. The plurality of phase elements are positioned between the plurality of radiating elements and a low noise amplifier.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a prior art schematic illustration of a passive Electronically Steerable Array;

FIG. 2 is a prior art schematic illustration of an active Electronically Steerable Array;

FIG. 3 is a prior art schematic illustration of the typical components in a T/R array such as the array of FIG. 2;

FIG. 4 is a prior art schematic illustration of the geometric positioning of components in an active Electronically Steerable Array;

FIG. 5 is a schematic illustration according to the present invention of the communication module that includes a HEMT T/R element;

FIG. 6 is a schematic, perspective illustration of the hybrid-phased array of the present invention where a plurality of communication modules are positioned above a single substrate; and

FIG. 7 is a schematic illustration of a T/R element of the present invention that includes a MEMS switch which connects to phased array which connects to an array of radiating elements.

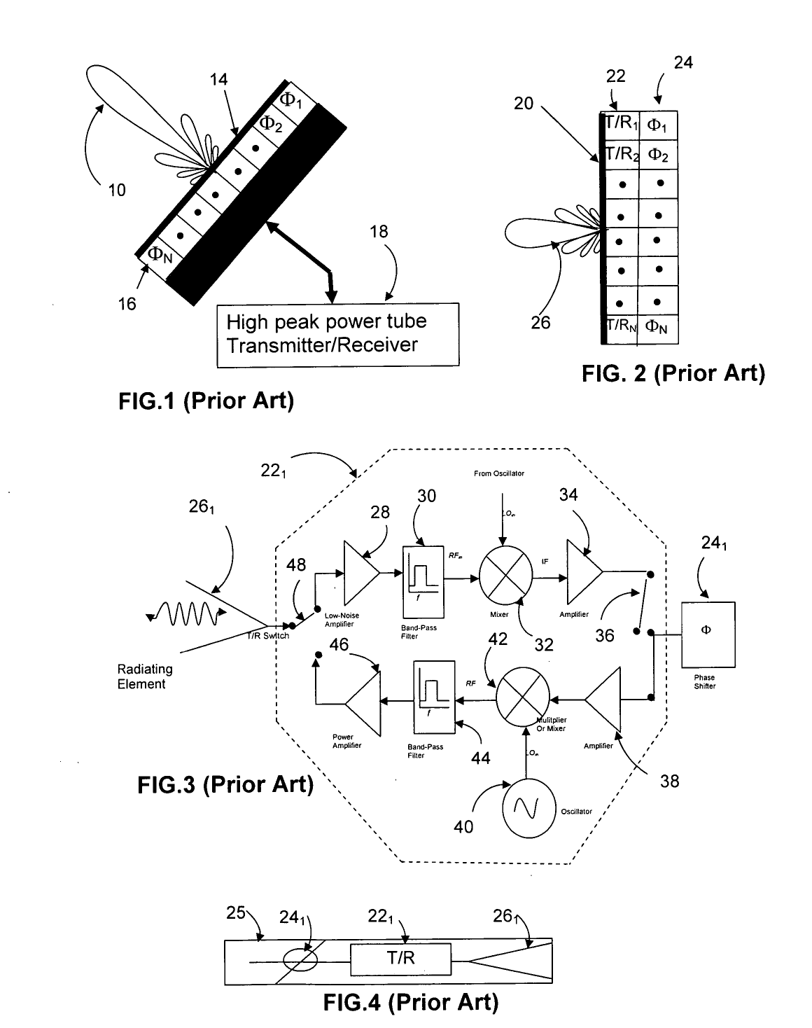

### DETAILED DESCRIPTON

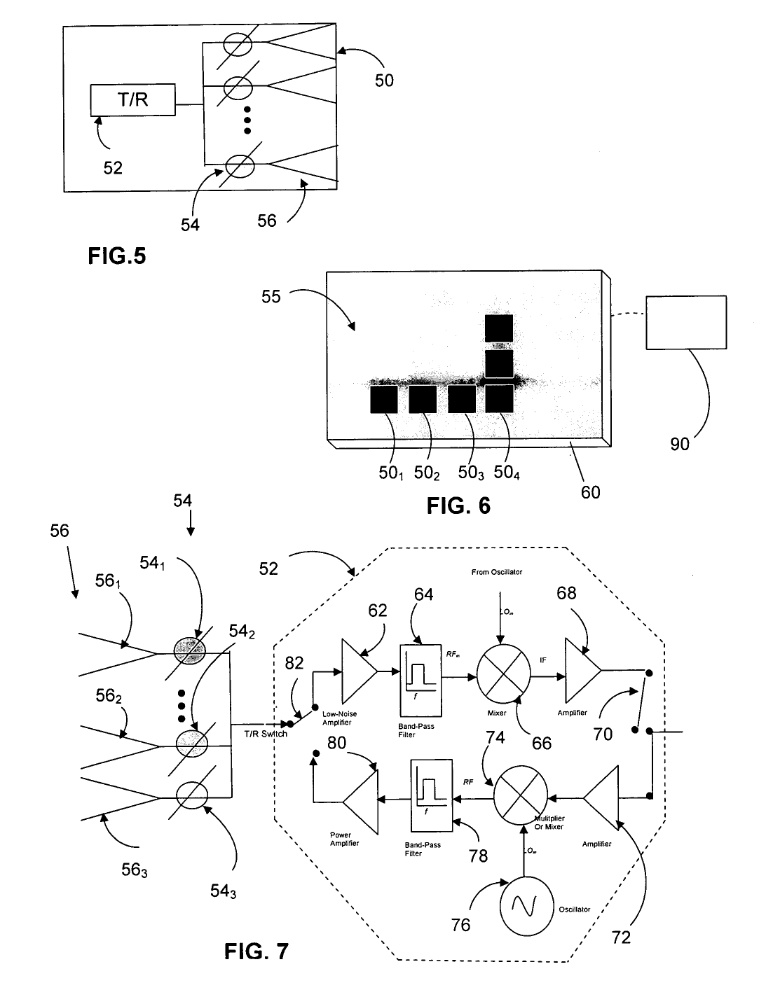

With reference to FIG. 5, a communication module 50 of the present invention has a transmit/receive module 52 that connects to a row 54 of phase elements. Each phase element in the row 54 of phase elements is connected to a corresponding radiating element in a row 56 of radiating elements.

In FIG. 6, a communication array 55 has a plurality of communication modules 50₁, 50₂, 50₃, 50₄, etc., that are positioned above substrate 60. The array is electrically connected to signal processing electronics 90.

In FIG. 7, the components of the transmit/receive module 52 include a T/R switch 82. The T/R switch 82 alternatively connects the row 54 of phase elements to low noise amplifier 62 during receive mode or to power amplifier 80 during transmit mode. Low-noise amplifier 62 connects to band-pass filter 64 that connects to a mixer 66. Mixer 66 mixes the received signal with a current received from an oscillator with the mixed signal proceeding to amplifier 68. Amplifier 68 connects to a switch 70 which opens and closes depending upon the mode of operation. Amplifier 72 connects to a multiplier or mixer 74 that connects to oscillator 76. A mixed signal proceeds from mixer 74 to band-pass filter 78 to the power amplifier 80.

When T/R switch 82 connects to power amplifier 80, a signal is transmitted to the radiating elements 56₁, 56₂, 56₃. Phase element 54₃ is directly connected to radiating element 56₃. Phase element 54₂ is directly connected to radiating element 56₂ and phase element 54₁ is directly connected to radiating element 56₁. Thus switch 82 connects to the respective phase elements of row 54 which connect to corresponding radiating elements in radiating row 56. Those of ordinary skill in the art realize that different arrangements and/or different components could be utilized to achieve a functional T/R element or module. However, any arrangement of internal T/R components, the use of a PHEMT design will enhance power capabilities. Also, however, the internal components of T/R module are arranged, it is necessary that a switch such as switch 82 be provided to allow for switching during the transmit and receive modes that provides low signal loss.

Each transmit/receive module 52 of the present invention is a psuedomorphic HEMT (PHEMT) so as to be capable of operation at voltages exceeding 10 volts. This power capability allows each transmit receive module to drive multiple radiating elements.

The T/R switch 82 that connects the phase elements 54₁, 54₂, 54₃, to the PHEMP-T/R element 52 of each communication module 50 is a high isolation switch.

The phase shift elements 54 are created using Radio Frequency Microeletromechanical System (RF MEMS) switches that provide low signal loss. This enables multiple phase elements to be driven by a single PHEMT-T/R element 52.

The piezoelectrically actuated structures of RF MEMS switches provide large actuation forces compared to electrostatic switches. Further, RF MEMS switches reduce stiction and thereby increase the reliability of the entire communication module 50.

The HEMT-T-R element 52 and the RF MEMS switch-based phasing elements of the present invention allow the phasing network 54 to be positioned between the radiating elements and the low noise amplifier 82 because RF MEMS provide for the manufacture of low-loss phasing networks.

The efficient and low cost properties of the present invention lend its application to a host of systems and functions ranging from expendable missiles to cell phone technology.

Accordingly, various modifications are possible without deviating from the spirit of the present invention. Accordingly the scope of the invention is limited only by the claim language which follows hereafter.

What is claimed is:

1. A communication module comprising:
a PHEMT-T/R module;
a plurality of phase elements;
a switching means connecting said PHEMT-T/R module to said plurality of phase elements;
a plurality of radiating elements; and
wherein each phase element of said plurality of phase elements is directly connected to a corresponding radiating element of said plurality of radiating elements.

2. A communication module according to claim 1, wherein:
said plurality of phase elements include said switching means that connects the PHEMT-T/R module to said plurality of radiating elements.

3. A communication device according to claim 2, wherein:
said switching means comprises an RF MEMS switch.

4. A communication device according to claim 1, wherein
said plurality of phase elements are positioned between said plurality of radiating elements and a low noise amplifier.

5. A communication device according to claim 2, wherein a
said plurality of phase elements are positioned between said plurality of radiating elements and a low noise amplifier.

6. A communication array, comprising:
a substrate;
a plurality of communication modules arranged on said substrate with each of said communication modules having a PHEMT-T/R module, a plurality of phase elements connecting to said PHEMT-T/R module and a plurality of radiating elements connecting to said plurality of phase elements.

7. A communication array according to claim 6, wherein:
each phase element of said plurality of phase elements has a MEMS switching means connecting to said PHEMT-T/R module;

8. A communication array according to claim 7, wherein:
said plurality of phase elements are positioned between said plurality of radiating elements and a low noise amplifier that connects to said PHEMT-T/R module.

9. A communication array according to claim 6 wherein:
said plurality of phase elements are RF MEMS switch-based phasing elements.
